(19) United States
(12) Patent Application Publication
(10) Pub. No.: US 2021/0317238 A1
(43) Pub. Date: Oct. 14, 2021

(54) Bis(Metallocene) Compounds and Catalyst Compositions Employing Such Compounds

(71) Applicants: Total Research & Technology Feluy, Seneffe (BE); CENTRE NATIONAL DE LA RECHERCHE SCIENTIFIQUE (CNRS), Paris (FR)

(72) Inventors: Alexandre Welle, Court-St-Etienne (BE); Aurélien Vantomme, Mignault (BE); Jean-François Carpentier, Acigné (FR); Gilles Schnee, Montpellier (FR); Olivier Miserque, Mont-Saint-Guibert (BE); Evgueni Kirillov, Cesson Sevigne (FR)

(21) Appl. No.: 16/330,612

(22) PCT Filed: Sep. 7, 2017
(86) PCT No.: PCT/EP2017/072395

§ 371 Date: Mar. 5, 2019

(30) Foreign Application Priority Data
Sep. 8, 2016 (EP) 16290166.4

(51) Int. Cl. C08F 4/6592; C08F 4/642; C08F 210/02; C08F 210/06

(52) U.S. Cl. CPC C08F 4/65927; C08F 4/6423; C08F 2410/03; C08F 210/02; C08F 210/06; C08F 4/6428

(57) ABSTRACT

The present invention relates to new bis(metallocene) compounds, new catalyst compositions, process for preparing the new bis(metallocene) compounds and use of said new catalyst compositions to polymerise olefins. The bis(metallocene) compounds of the invention are homo- or hetero bis(metallocene) molecules in which same or different metallocene moieties are connected by a phenylene bridge. The phenylene bridge is either para-substituted, meta-substituted or ortho-substituted by the two metallocene moieties.

### FIELD OF THE INVENTION

The present invention relates to the field of polyolefin polymerisation catalysis, catalyst compositions, methods for the polymerisation and copolymerisation of olefins and polyolefins obtained. More specifically, this invention relates to bis(metallocene) compounds and catalyst compositions employing such compounds.

### BACKGROUND OF THE INVENTION

A constant mechanical properties improvement is required in the field of the polymer industry. Such improvement can, for example, be obtained by tailor made bimodal resins synthesized by metallocene catalysts combined with cascade reactor. However, the requirement of multiple reactors leads to increase costs for both construction and operation, and this can be overcome by using multiple catalysts in a single reactor.

Such use of multiple catalysts can be done by proceeding to separate catalyst injections in the reactor. Although this process shows high flexibility, several drawbacks must be highlighted: multiple catalysts injections lead to increased costs, polymer homogeneity is difficult to achieve and some process limitation appears due to production of low melting polymer.

Another strategy is the heterogenisation of multiple catalysts on the same support that can tackle those drawbacks. However, this technology suffers from the difficulty to control properly the behavior of a metallocene complex during the heterogenisation process typically leading to a dominating structure while the other seems inactive.

WO2004/076502 discloses such a supported multinuclear metallocene catalyst for olefin polymerization comprising (A) a dinuclear metallocene catalyst, (B) a mononuclear metallocene catalyst, (C) an activator for activating the catalysts, and a support; the dinuclear metallocene catalyst having a biaryl linker. Thus, there is still a need for catalysts compositions that can achieve the production of multimodal products without the heterogenisation of multiple catalysts on the same support.

Thus, it is an object of the invention to provide metallocene compounds and catalyst compositions using such metallocene compounds for the polymerisation of bi- or multimodal polyolefin resins with improved mechanical properties and/or homogeneity that can be synthesized in single reactor processes.

It is also an object of the invention to provide a process to develop synthetic procedures for such metallocene compounds.

### SUMMARY OF THE INVENTION

According to a first aspect, the invention provides a bis(metallocene) compound (A) having one of the following formulas:

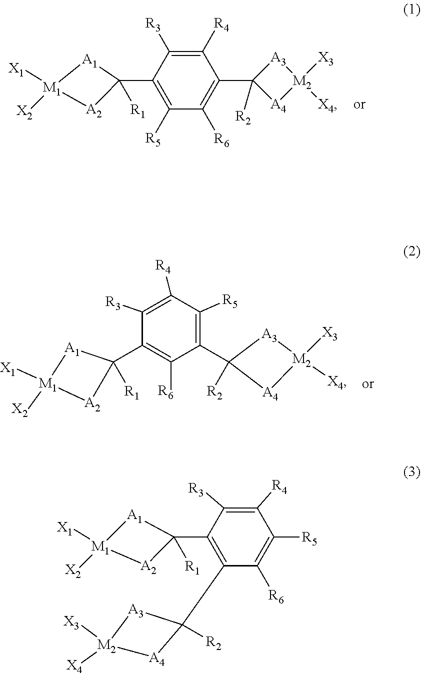

wherein
A1 and A3 are the same or different substituted or unsubstituted cyclopentadienyl rings, or substituted or unsubstituted fluorenyl rings, or substituted or unsubstituted indenyl rings, wherein if substituted, the substitutions may be independent and/or linked to form multicyclic structures.
A2 and A4 are the same or different and selected from substituted or unsubstituted cyclopentadienyl rings, or substituted or unsubstituted fluorenyl rings, or substituted or unsubstituted indenyl rings.
X1, X2, X3 and X4 are independently hydrogen, halogen, hydride group, hydrocarbyl group, substituted hydrocarbyl group, alkoxide group, substituted alkoxide group, aryloxide group, substituted aryloxide group, halocarbyl group, substituted halocarbyl group, silylcarbyl group, substituted silylcarbyl group, germylcarbyl group, substituted germylcarbyl group, or both X1 and X2 and/or both X3 and X4 are joined and bound to the metal atom to form a metallacycle ring containing from 3 to 20 carbon atoms.
M1 is Zirconium.
M2 is selected from Zirconium, Hafnium and Titanium.
R1 and R2 are independently hydrogen or a substituted or unsubstituted aliphatic, aromatic, or cyclic group.
R3, R4, R5 and R6 are independently hydrogen or a substituted or unsubstituted aliphatic, aromatic, or cyclic group.

With preference one or more of the following embodiments can be used to define the inventive bis(metallocene) compound (A):
The bis(metallocene) compound (A) has one of the following formulas:

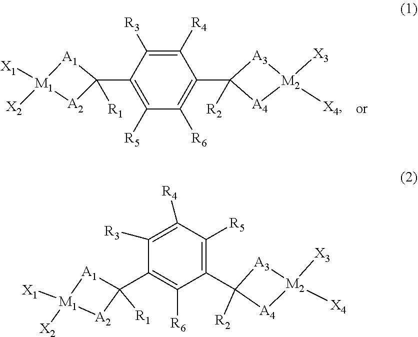

wherein
A1 and A3 are the same or different substituted or unsubstituted cyclopentadienyl rings, or substituted or unsubstituted fluorenyl rings, or substituted or unsubstituted indenyl rings, wherein if substituted, the substitutions may be independent and/or linked to form multicyclic structures.
A2 and A4 are the same or different and selected from substituted or unsubstituted cyclopentadienyl rings, or substituted or unsubstituted fluorenyl rings, or substituted or unsubstituted indenyl rings.
X1, X2, X3 and X4 are independently hydrogen, halogen, hydride group, hydrocarbyl group, substituted hydrocarbyl group, alkoxide group, substituted alkoxide group, aryloxide group, substituted aryloxide group, halocarbyl group, substituted halocarbyl group, silylcarbyl group, substituted silylcarbyl group, germylcarbyl group, substituted germylcarbyl group, or both X1 and X2 and/or both X3 and X4 are joined and bound to the metal atom to form a metallacycle ring containing from 3 to 20 carbon atoms.
M1 is Zirconium.
M2 is selected from Zirconium, Hafnium and Titanium.
R1 and R2 are independently hydrogen or a substituted or unsubstituted aliphatic, aromatic, or cyclic group.
R3, R4, R5 and R6 are independently hydrogen or a substituted or unsubstituted aliphatic, aromatic, or cyclic group.
The bis(metallocene) compound (A) has the following formula:

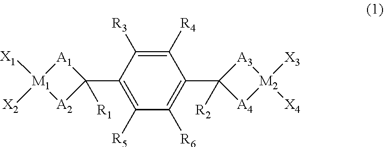

wherein
A1 and A3 are the same or different substituted or unsubstituted cyclopentadienyl rings, or substituted or unsubstituted fluorenyl rings, or substituted or unsubstituted indenyl rings, wherein if substituted, the substitutions may be independent and/or linked to form multicyclic structures.
A2 and A4 are the same or different and selected from substituted or unsubstituted cyclopentadienyl rings, or substituted or unsubstituted fluorenyl rings, or substituted or unsubstituted indenyl rings.
X1, X2, X3 and X4 are independently hydrogen, halogen, hydride group, hydrocarbyl group, substituted hydrocarbyl group, alkoxide group, substituted alkoxide group, aryloxide group, substituted aryloxide group, halocarbyl group, substituted halocarbyl group, silylcarbyl group, substituted silylcarbyl group, germylcarbyl group, substituted germylcarbyl group, or both X1 and X2 and/or both X3 and X4 are joined and bound to the metal atom to form a metallacycle ring containing from 3 to 20 carbon atoms.
M1 is Zirconium.
M2 is selected from Zirconium, Hafnium and Titanium.
R1 and R2 are independently hydrogen or a substituted or unsubstituted aliphatic, aromatic, or cyclic group.
R3, R4, R5 and R6 are independently hydrogen or a substituted or unsubstituted aliphatic, aromatic, or cyclic group.
A1 and A3 are the same and A2 and A4 are the same so that the bis(metallocene) compound (A) shows a symmetry.
A1 and A3 are the same or different substituted or unsubstituted cyclopentadienyl rings, or substituted or unsubstituted fluorenyl rings, wherein if substituted, the substitutions may be independent and/or linked to form multicyclic structures.
A1 and A3 are the same or different substituted or unsubstituted cyclopentadienyl rings wherein if substituted, the substitutions may be independent and/or linked to form multicyclic structures.
A1 and A3 are the same or different substituted or unsubstituted fluorenyl rings wherein if substituted, the substitutions may be independent and/or linked to form multicyclic structures.
A1 and A3 are the same or different substituted or unsubstituted indenyl rings, wherein if substituted, the substitutions may be independent and/or linked to form multicyclic structures.
A2 and A4 are the same or different and selected from substituted or unsubstituted cyclopentadienyl rings, or substituted or unsubstituted fluorenyl rings.
Both M1 and M2 are zirconium or M1 and M2 are different and preferably M2 is Hafnium.
R1 and R2 are independently hydrogen or a methyl group.
R3, R4, R5 and R6 are hydrogen.
At least one of A1, A2, A3 or A4 is a fluorenyl ring.
The compound is:

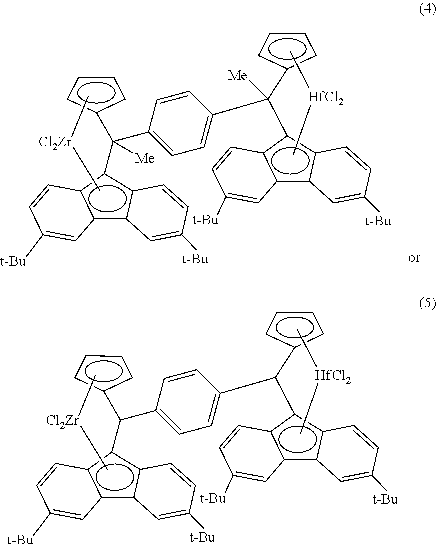

According to a second aspect the invention provides a catalyst composition comprising a bis(metallocene) compound (A) as defined in the first aspect and/or its embodiments and a co-catalyst (B).

With preference one or more of the following embodiments can be used to define the inventive catalyst composition:
The co-catalyst (B) is an alumoxane selected from methylalumoxane, modified methyl alumoxane, ethylalumoxane, isobutylalumoxane, or any combination thereof, preferably the co-catalyst (B) is methylalumoxane (MAO).
the co-catalyst (B) is an ionic activator selected from dimethylanilinium tetrakis(perfluorophenyl)borate, triphenylcarbonium tetrakis (perfluorophenyl) borate, dimethylanilinium tetrakis(perfluorophenyl)aluminate, or any combination thereof, preferably the ionic activator is dimethylanilinium tetrakis(perfluorophenyl)borate.
The co-catalyst (B) is an ionic activator used in combination with a co-activator being a trialkylaluminium selected from Tri-Ethyl Aluminum (TEAL), Tri-Iso-Butyl Aluminum (TIBAL), Tri-Methyl Aluminum (TMA), and Methyl-Methyl-Ethyl Aluminum (MMEAL), preferably the co-activator is Tri-Iso-Butyl Aluminum (TIBAL).
The bis(metallocene) compound (A) comprises a mixture of a homo bis(metallocene) wherein both M1 and M2 are zirconium and of a hetero bis(metallocene) wherein M1 and M2 are different and further wherein preferably M2 is hafnium. With preference, the bis(metallocene) compound (A) comprises at least 10 w % of a hetero bis(metallocene) wherein M1 and M2 are different, based on the total weight of the bis(metallocene) compound (A).

According to a third aspect, the invention relates to the use of the catalyst composition as defined in the second aspect and/or its embodiments in a process for polymerising olefins, the process comprising the step of contacting said catalyst composition with an olefin monomer and optionally an olefin comonomer under polymerisation conditions to produce an olefin polymer. Preferably, said olefin monomer is ethylene or propylene.

In a preferred embodiment, the polyolefin obtained has a bimodal or multimodal distribution as evidenced by TREF analysis.

According to a fourth aspect, the invention provides a process for preparing a bis(metallocene) compound (A) as defined in the first aspect and/or its embodiments comprising the step of conducting a metathesis reaction of a metal precursor and a proligand wherein the proligand has one of the following formulas:

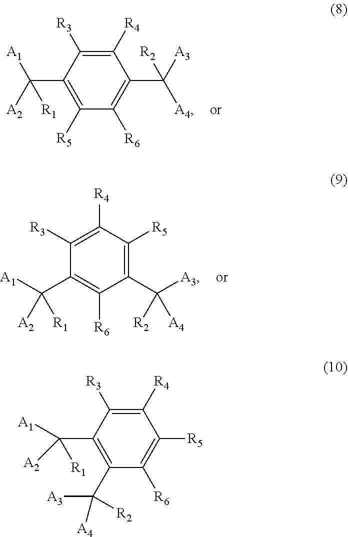

wherein
A1 and A3 are the same or different substituted or unsubstituted cyclopentadienyl rings, or substituted or unsubstituted fluorenyl rings, or substituted or unsubstituted indenyl rings, wherein if substituted, the substitutions may be independent and/or linked to form multicyclic structures.
A2 and A4 are the same or different and selected from substituted or unsubstituted cyclopentadienyl rings, or substituted or unsubstituted fluorenyl rings, or substituted or unsubstituted indenyl rings.
R1 and R2 are independently hydrogen or a substituted or unsubstituted aliphatic, aromatic, or cyclic group.
R3, R4, R5 and R6 are independently hydrogen or a substituted or unsubstituted aliphatic, aromatic, or cyclic group.

With preference one or more of the following embodiments can be used to define the inventive process:
The proligand has one of the following formulas:

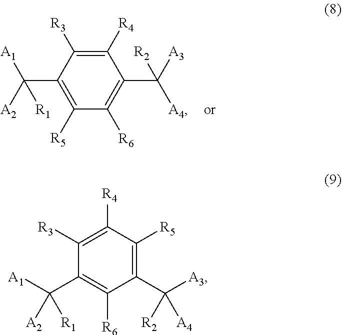

wherein
A1 and A3 are the same or different substituted or unsubstituted cyclopentadienyl rings, or substituted or unsubstituted fluorenyl rings, or substituted or unsubstituted indenyl rings, wherein if substituted, the substitutions may be independent and/or linked to form multicyclic structures.
A2 and A4 are the same or different and selected from substituted or unsubstituted cyclopentadienyl rings, or substituted or unsubstituted fluorenyl rings, or substituted or unsubstituted indenyl rings.
R1 and R2 are independently hydrogen or a substituted or unsubstituted aliphatic, aromatic, or cyclic group.
R3, R4, R5 and R6 are independently hydrogen or a substituted or unsubstituted aliphatic, aromatic, or cyclic group.
The proligand has the following formula:

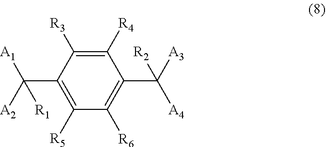

wherein
A1 and A3 are the same or different substituted or unsubstituted cyclopentadienyl rings, or substituted or unsubstituted fluorenyl rings, or substituted or unsubstituted indenyl rings, wherein if substituted, the substitutions may be independent and/or linked to form multicyclic structures.
A2 and A4 are the same or different and selected from substituted or unsubstituted cyclopentadienyl rings, or substituted or unsubstituted fluorenyl rings, or substituted or unsubstituted indenyl rings.
R1 and R2 are independently hydrogen or a substituted or unsubstituted aliphatic, aromatic, or cyclic group.
R3, R4, R5 and R6 are independently hydrogen or a substituted or unsubstituted aliphatic, aromatic, or cyclic group.
A1 and A3 are the same or different substituted or unsubstituted cyclopentadienyl rings, or substituted or unsubstituted fluorenyl rings, wherein if substituted, the substitutions may be independent and/or linked to form multicyclic structures.
A1 and A3 are the same or different substituted or unsubstituted cyclopentadienyl rings wherein if substituted, the substitutions may be independent and/or linked to form multicyclic structures.
A1 and A3 are the same or different substituted or unsubstituted fluorenyl rings wherein if substituted, the substitutions may be independent and/or linked to form multicyclic structures.
A1 and A3 are the same or different substituted or unsubstituted indenyl rings, wherein if substituted, the substitutions may be independent and/or linked to form multicyclic structures.
A2 and A4 are the same or different and selected from substituted or unsubstituted cyclopentadienyl rings, or substituted or unsubstituted fluorenyl rings.
The proligand is a bis (Cp/Flu) proligand of the following formula

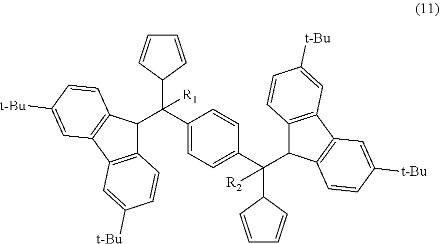

wherein R1 and R2 are independently hydrogen or a substituted or unsubstituted aliphatic, aromatic, or cyclic group.
The metal precursor is one or more selected from zirconium tetrachloride (ZrCl₄), hafnium tetrachloride (HfCl₄) and titanium tetrachloride (TiCl₄), wherein hafnium tetrachloride (HfCl₄) is not selected alone.
The metal precursor is zirconium tetrachloride (ZrCl₄) and the bis(metallocene) compound is a homo bis(metallocene) .
The metal precursor is a mixture of zirconium tetrachloride (ZrCl₄) with hafnium tetrachloride (HfCl₄) and/or titanium tetrachloride (TiCl₄) and the bis(metallocene) compound is a hetero bis(metallocene).
The process further comprises the step of synthesis of a proligand by reacting two difulvenes together.
The process further comprises the step of synthesis of ortho- or meta- or para-substituted difulvenes by nucleophilic addition of fluorenyl anions to fulvenes, preferably the catalyst used for this nucleophilic addition is pyrolidine.

It is noted that other bis(metallocene) compositions are already disclosed in prior art such as in WO2010/151315. However, this document does not disclose obtaining bimodal polyolefins in a single reactor.

### DESCRIPTION OF THE FIGURES

FIGS. 1a and 1b are the mass spectrum of the mixture of homo- and hetero bis(metallocene) compound (5a and 5b) as obtained according to Scheme 8, evidencing the presence of hetero zirconium-hafnium complexes.

FIG. 2 represents a graph plotting a TREF (temperature rising elution fractionation) profile (dW/dT (%/° C.)) as a function of temperature for MDPE resins synthesized with or without the catalyst composition according to the invention.

### DETAILED DESCRIPTION OF THE INVENTION

For the purpose of the invention the following definitions are given:

As used herein, a “polymer” is a polymeric compound prepared by polymerising monomers, whether of the same or a different type. The generic term polymer thus embraces the term homopolymer, usually employed to refer to polymers prepared from only one type of monomer, and the terms copolymer and interpolymer as defined below.

As used herein, a “copolymer”, “interpolymer” and like terms mean a polymer prepared by the polymerisation of at least two different types of monomers. These generic terms include polymers prepared from two or more different types of monomers, i.e. terpolymers, tetrapolymers, etc.

For the purpose of the invention, the terms “polypropylene” (PP) and “propylene polymer” may be used synonymously. The term “metallocene polypropylene” is used to denote a polypropylene produced with a metallocene catalyst. The produced metallocene polypropylene may be labeled as “mPP”. A metallocene propylene copolymer can be derived from propylene and a comonomer such as one or more selected from the group consisting of ethylene and C₄-C₁₀ alpha-olefins, such as 1-butene, 1-pentene, 1-hexene, 1-octene.

In a similar way, the terms “polyethylene” (PE) and “ethylene polymer” may be used synonymously. The term “metallocene polyethylene” is used to denote a polyethylene produced with a metallocene catalyst. The produced “metallocene polyethylene” may be labeled as “mPE”. A metallocene ethylene copolymer can be derived from ethylene and a comonomer such as one or more selected from the group consisting of C₃-C₁₀ alpha-olefins, such as 1-butene, 1-propylene, 1-pentene, 1-hexene, 1-octene.

The term “co-catalyst” is used generally herein to refer to organoaluminum compounds that can constitute one component of a catalyst composition. Additionally, “co-catalyst” refers to other component of a catalyst composition including, but not limited to, aluminoxanes, organoboron or organoborate compounds and ionizing ionic compound (i.e. ionic activator).

The term “co-catalyst” is used regardless of the actual function of the compound or any mechanical mechanism by which the compound may operate. In one aspect of this invention the term “co-catalyst” is used to distinguish that component of the catalyst composition from the bis(metallocene) compound.

The term “bis(metallocene)”, as used herein, describes a compound comprising two metallocene moieties linked by a phenylene group.

Unless otherwise specified the following abbreviations may be used: Cp for cyclopentadienyl, Ind for indenyl, and Flu for fluorenyl.

For any particular compound disclosed herein, any general or presented structure presented also encompasses all conformational isomers, regioisomers, and stereoisomers that may arise from a particular set of substituents. The general or specific structure also encompasses all enantiomers, diastereomers, and other optical isomers whether in enantiomeric or racemic forms, as well as mixtures of stereoisomers, as would be recognized by a person skilled in the art.

The terms “comprising”, “comprises” and “comprised of” as used herein are synonymous with “including”, “includes” or “containing”, “contains”, and are inclusive or open-ended and do not exclude additional, non-recited members, elements or method steps. The terms “comprising”, “comprises” and “comprised of” also include the term “consisting of”.

The recitation of numerical ranges by endpoints includes all numbers and fractions subsumed within the respective ranges, as well as the recited endpoints.

The particular features, structures, characteristics or embodiments may be combined in any suitable manner, as would be apparent to a person skilled in the art from this disclosure, in one or more embodiments.

The present invention is generally directed to new bis(metallocene) compounds, new catalyst compositions, process for preparing the new bis(metallocene) compounds and use of said new catalyst compositions to polymerise olefins. In particular, the invention relates to bis(metallocene) compounds and catalyst compositions employing such compounds.

The bis(metallocene) of the invention are homo- or heterodinuclear molecules in which same or different metallocene moieties are connected by a phenylene bridge. The phenylene bridge is para-substituted, meta-substituted or ortho-substituted by the two metallocene moieties.

The present invention discloses compounds having two same or distinct metallocene moieties linked by a phenylene group, and methods for making these new compounds.

These compounds are commonly referred to as bis(metallocene) compounds or dinuclear compounds, or binuclear compounds, or bimetallic compounds, because they contain two metal centers. Accordingly, in one aspect of this invention the bis(metallocene) compounds have the formula:

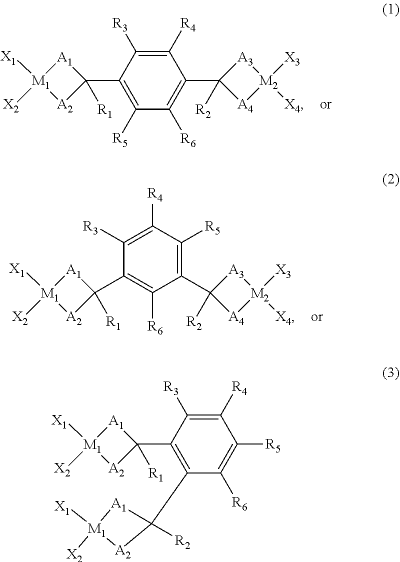

wherein
A1 and A3 are the same or different substituted or unsubstituted cyclopentadienyl rings, or substituted or unsubstituted fluorenyl rings, or substituted or unsubstituted indenyl rings, wherein if substituted, the substitutions may be independent and/or linked to form multicyclic structures.
A2 and A4 are the same or different and selected from substituted or unsubstituted cyclopentadienyl rings, or substituted or unsubstituted fluorenyl rings, or substituted or unsubstituted indenyl rings.
X1, X2, X3 and X4 are independently hydrogen, halogen, hydride group, hydrocarbyl group, substituted hydrocarbyl group, alkoxide group, substituted alkoxyde group, ariloxide group, substituted aryloxide group, halocarbyl group, substituted halocarbyl group, silylcarbyl group, substituted silylcarbyl group, germylcarbyl group, substituted germylcarbyl group, or both X1 and X2 and/or both X3 and X4 are joined and bound to the metal atom to form a metallacycle ring containing from 3 to 20 carbon atoms.
M1 is Zirconium.
M2 is selected from Zirconium, Hafnium and Titanium.
R1 and R2 are independently hydrogen or a substituted or unsubstituted aliphatic, aromatic, or cyclic group.
R3, R4, R5 and R6 are independently hydrogen or a substituted or unsubstituted aliphatic, aromatic, or cyclic group.

In these formulas halogen includes fluorine (F), chlorine (Cl), bromine (Br), and iodine (I) atoms.

As used herein, an aliphatic group includes linear or branched alkyl and alkenyl groups. Generally, the aliphatic group contains from 1 to 20 carbon atoms. Unless otherwise specified, alkyl and alkenyl groups described herein are intended to include all structural isomers, linear or branched, of a given moiety; for example, all enantiomers and all diastereomers are included within this definition. As an example, unless otherwise specified, the term propyl is meant to include n-propyl and iso-propyl, while the term butyl is meant to include n-butyl, iso-butyl, t-butyl, sec -butyl, and so forth.

Suitable examples of alkyl groups which can be employed in the present invention include, but are not limited to, methyl, ethyl, propyl, butyl, pentyl, hexyl, heptyl, octyl, nonyl, or decyl, and the like. Examples of alkenyl groups within the scope of the present invention include, but are not limited to, ethenyl, propenyl, butenyl, pentenyl, hexenyl, heptenyl, octenyl, nonenyl, decenyl, and the like.

Aromatic groups and combinations with aliphatic groups include aryl and arylalkyl groups, and these include, but are not limited to, phenyl, alkyl-substituted phenyl, naphthyl, alkyl-substituted naphthyl, phenyl-substituted alkyl, naphthyl-substituted alkyl, and the like. Generally, such groups and combinations of groups contain less than about 20 carbon atoms. Hence, non-limiting examples of such moieties that can be used in the present invention include phenyl, tolyl, benzyl, dimethylphenyl, trimethylphenyl, phenylethyl, phenylpropyl, phenylbutyl, propyl-2phenylethyl, and the like.

Cyclic groups include cycloalkyl and cycloalkenyl moieties and such moieties can include, but are not limited to, cyclopentyl, cyclopentenyl, cyclohexyl, cyclohexenyl, and the like. One example of a combination including a cyclic group is a cyclohexylphenyl group.

Unless otherwise specified, any substituted aromatic or cyclic moiety used herein is meant to include all regioisomers; for example, the term tolyl is meant to include any possible substituent position, i.e. ortho, meta, or para.

Hydrocarbyl is used herein to specify a hydrocarbon radical group that includes, but is not limited to, aryl, alkyl, cycloalkyl, alkenyl, cycloalkenyl, cycloalkadienyl, alkynyl, aralkyl, aralkenyl, aralkynyl, and the like, and includes all substituted, unsubstituted, branched, linear, and/or heteroatom substituted derivatives thereof. Unless otherwise specified, the hydrocarbyl groups of this invention typically comprise up to about 20 carbon atoms. In another aspect, hydrocarbyl groups can have up to 12 carbon atoms, for instance, up to 8 carbon atoms, or up to 6 carbon atoms.

Alkoxide and aryloxide groups both can comprise up to about 20 carbon atoms. Illustrative and non-limiting examples of alkoxide and aryloxide groups include methoxy, ethoxy, propoxy, butoxy, phenoxy, substituted phenoxy, and the like.

Silylcarbyl groups are groups in which the silyl functionality is bonded directly to the indicated atom or atoms. Examples include SiH₃, SiH₂R*, SiHR*₂, SiR*₃, SiH₂(OR*), SiH(OR*)₂, Si(OR*)₃, SiH₂(NR*₂), SiH(NR*₂)₂, Si(NR*₂)₃, and the like where R* is independently a hydrocarbyl or halocarbyl radical and two or more R* may join together to form a substituted or unsubstituted saturated, partially unsaturated or aromatic cyclic or polycyclic ring structure.

Germylcarbyl groups are groups in which the germyl functionality is bonded directly to the indicated atom or atoms. Examples include GeH₃, GeH₂R*, GeHR*₂, GeR*₃, GeH₂(OR*), GeH(OR*)₂, Ge(OR*)₃, GeH₂(NR*₂), GeH(NR*₂)₂, Ge(NR*₂)₃, and the like where R* is independently a hydrocarbyl or halocarbyl radical and two or more R* may join together to form a substituted or unsubstituted saturated, partially unsaturated or aromatic cyclic or polycyclic ring structure.

In a preferred embodiment, A1 and A3 are the same and A2 and A4 are the same so that the bis(metallocene) compound (A) shows a symmetry.

In another preferred embodiment R1 and R2 are independently hydrogen or a methyl group, and/or R3, R4, R5 and R6 are hydrogen, and/or, at least one of A1, A2, A3 or A4 is a fluorenyl ring.

The bis(metallocene) compound of the invention may be hetero bis(metallocene) compound because each metallocene moiety linked by the phenylene bridge is different and/or contain a different metal center. Non-limiting examples of hetero bis(metallocene) compounds in accordance with the invention have the following formulas:

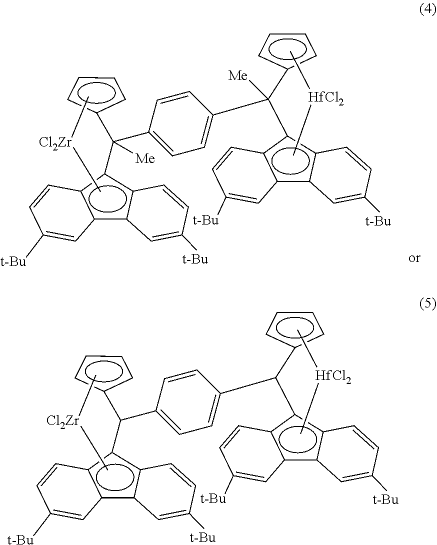

The bis(metallocene) compound of the invention may be homo bis(metallocene) compound because each metallocene moiety linked by the phenylene bridge is the same and contain the same metal center. Non-limiting examples of homo bis(metallocene) compounds in accordance with the invention have the following formulas:

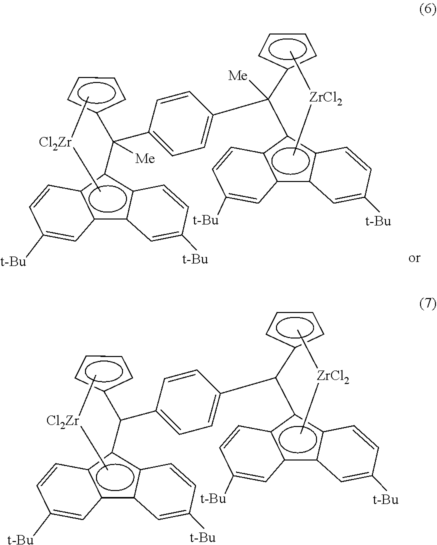

Methods of making bis(metallocene) compounds of the present invention are also provided. Bis(metallocene) compounds were obtained using a standard salt metathesis reaction between two equivalents of the metal precursors and the corresponding tetra anions ligand.

The metal precursor is a mixture of zirconium tetrachloride (ZrCl₄) with one selected from zirconium tetrachloride (ZrCl₄), hafnium tetrachloride (HfCl₄), titanium tetrachloride (TiCl₄), zirconium tetrachloride complex 1:2 with tetrahydrofuran (ZrCl₄.2THF), hafnium tetrachloride complex 1:2 with tetrahydrofuran (HfCl₄.2THF) and titanium tetrachloride complex 1:2 with tetrahydrofuran (TiClhd 4.2THF).

The proligand has one of the following formulas:

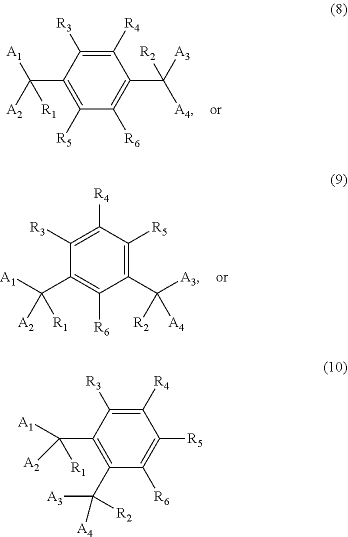

wherein
A1 and A3 are the same or different substituted or unsubstituted cyclopentadienyl rings, or substituted or unsubstituted fluorenyl rings, or substituted or unsubstituted indenyl rings, wherein if substituted, the substitutions may be independent and/or linked to form multicyclic structures;
A2 and A4 are the same or different and selected from substituted or unsubstituted cyclopentadienyl rings, or substituted or unsubstituted fluorenyl rings, or substituted or unsubstituted indenyl rings;
R1 and R2 are independently hydrogen or a substituted or unsubstituted aliphatic, aromatic, or cyclic group;
R3, R4, R5 and R6 are independently hydrogen or a substituted or unsubstituted aliphatic, aromatic, or cyclic group.
For example the proligand is a bis (Cp/Flu) proligand of the following formula

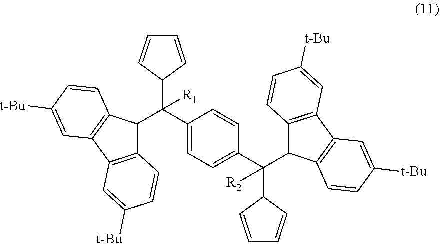

wherein R1 and R2 are independently hydrogen or a substituted or unsubstituted aliphatic, aromatic, or cyclic group.

Synthesis process of such proligand is well known to the person skilled in the art and is described for example in U.S. Pat. Nos. 2,512,698 and 2,58,7791. With preference, in the invention, pyrolidine is used as catalyst of the reaction.

The catalyst composition according to the invention comprises a bis(metallocene) compound (A) as defined above and a co-catalyst (B).

In a preferred embodiment the co-catalyst (B) is an alumoxane selected from methylalumoxane, modified methyl alumoxane, ethylalumoxane, isobutylalumoxane, or any combination thereof, preferably the co-catalyst (B) is methylalumoxane (MAO).

In another preferred embodiment, the co-catalyst (B) is an ionic activator selected from dimethylanilinium tetrakis(perfluorophenyl)borate, triphenylcarbonium tetrakis (perfluorophenyl) borate, dimethylanilinium tetrakis(perfluorophenyl)aluminate, or any combination thereof, preferably the ionic activator is dimethylanilinium tetrakis(perfluorophenyl)borate. In such a case the co-catalyst (B) is preferably used in combination with a co-activator being a trialkylaluminium selected from Tri-Ethyl Aluminum (TEAL), Tri-Iso-Butyl Aluminum (TIBAL), Tri-Methyl Aluminum (TMA), and Methyl-Methyl-Ethyl Aluminum (MMEAL), preferably the co-activator is Tri-Iso-Butyl Aluminum (TIBAL).

In a preferred embodiment, the bis(metallocene) compound (A) comprises a mixture of a homo bis(metallocene) wherein both M1 and M2 are zirconium and of a hetero bis(metallocene) wherein M1 and M2 are different and further wherein preferably M2 is hafnium. Preferably, in such a case, the proligand used to produce the bis(metallocene) compound is the same in the homo bis(metallocene) and in the hetero bis(metallocene). The mixture of homo- and hetero bis(metallocene) compound is obtained by reaction of metal precursors and a tetra anion ligand.

The metallocene may be supported according to any method known in the art. In the event it is supported, the support used in the present invention can be any organic or inorganic solid, particularly porous support such as silica, talc, inorganic oxides, and resinous support material such as polyolefin. Preferably, the support material is an inorganic oxide in its finely divided form.

The polymerisation of propylene and one or more optional comonomers in the presence of the bis(metallocene) catalyst composition according to the invention can be carried out according to known techniques in one or more polymerisation reactors. With preference, the polymerisation of propylene and one or more optional comonomers in presence of bis(metallocene) catalyst composition according to the invention is carried out in a single polymerisation reactor.

The metallocene polypropylene is preferably produced by polymerisation in liquid propylene at temperatures in the range from 20° C. to 100° C. Preferably, temperatures are in the range from 60° C. to 80° C. The pressure can be atmospheric or higher, preferably between 25 and 50 bar. The molecular weight of the polymer chains, and in consequence the melt flow of the metallocene polypropylene, is mainly regulated by the addition of hydrogen to the polymerisation medium.

The polymerisation of ethylene and one or more optional comonomers in the presence of a bis(metallocene) catalyst composition can be carried out according to known techniques in one or more polymerisation reactors. With preference, the polymerisation of ethylene and one or more optional comonomers in the presence of bis(metallocene) catalyst composition according to the invention is carried out in a single polymerisation reactor. The metallocene polyethylene of the present invention is preferably produced by polymerisation in an “isobutane—ethylene—supported catalyst” slurry at temperatures in the range from 20° C. to 110° C., preferably in the range from 60° C. to 110° C. The pressure can be atmospheric or higher, preferably between 25 and 50 bar. The molecular weight of the polymer chains, and in consequence the melt flow of the metallocene polyethylene is mainly regulated by the addition of hydrogen in the polymerisation medium. The density of the polymer chains is regulated by the addition of one or more comonomers in the polymerisation medium.

Test Methods

Molecular weights are determined by Size Exclusion Chromatography (SEC) at high temperature (145° C.). A 10 mg polypropylene or polyethylene sample is dissolved at 160° C. in 10 mL of trichlorobenzene (technical grade) for 1 hour. Analytical conditions for the GPC_IR from Polymer Char are:
Injection volume: +/−400 μL;
Automatic sample preparation and injector temperature: 160° C.;
Column temperature: 145° C.;
Detector temperature: 160° C.;
Column set: 2 Shodex AT-806MS and 1 Styragel HT6E;
Flow rate: 1 ml/min;
Detector: IRS Infrared detector (2800-3000 cm⁻¹);
Calibration: Narrow standards of polystyrene (commercially available);
Calculation for polypropylene: Based on Mark-Houwink relation (log₁₀(M_{PP})=log₁₀(M_{PS})−0.25323); cut off on the low molecular weight end at M_{PP}=1000;
Calculation for polyethylene: Based on Mark-Houwink relation (log₁₀(M_{PE})=0.965909×log₁₀(M_{PS})−0.28264); cut off on the low molecular weight end at M_{PE}=1000.

The molecular weight averages used in establishing molecular weight/property relationships are the number average (Mₙ), weight average (M_{w}) and z average (M_{z}) molecular weight. These averages are defined by the following expressions and are determined form the calculated Mᵢ:

$${M}_{n} = \frac{{\sum }_{i} {N}_{i} {M}_{i}}{{\sum }_{i} {N}_{i}} = \frac{{\sum }_{i} {W}_{i}}{{\sum }_{i} {W}_{i} / {M}_{i}} = \frac{{\sum }_{i} {h}_{i}}{{\sum }_{i} {h}_{i} / {M}_{i}}$$

$${M}_{w} = \frac{{\sum }_{i} {N}_{i} {M}_{i}^{2}}{{\sum }_{i} {N}_{i} {M}_{i}} = \frac{{\sum }_{i} {W}_{i} {M}_{i}}{{\sum }_{i} {M}_{i}} = \frac{{\sum }_{i} {h}_{i} {M}_{i}}{{\sum }_{i} {M}_{i}}$$

$${M}_{z} = \frac{{\sum }_{i} {N}_{i} {M}_{i}^{3}}{{\sum }_{i} {N}_{i} {M}_{i}^{2}} = \frac{{\sum }_{i} {W}_{i} {M}_{i}^{2}}{{\sum }_{i} {W}_{i} {M}_{i}} = \frac{{\sum }_{i} {h}_{i} {M}_{i}^{2}}{{\sum }_{i} {h}_{i} {M}_{i}}$$

Here Nᵢ and Wᵢ are the number and weight, respectively, of molecules having molecular weight Mi. The third representation in each case (farthest right) defines how one obtains these averages from SEC chromatograms. hᵢ is the height (from baseline) of the SEC curve at the iₜₕ elution fraction and Mᵢ is the molecular weight of species eluting at this increment.

The molecular weight distribution (MWD or D) is then calculated as Mw/Mn.

The ¹³C-NMR analysis is performed using a 400 MHz or 500 MHz Bruker NMR spectrometer under conditions such that the signal intensity in the spectrum is directly proportional to the total number of contributing carbon atoms in the sample. Such conditions are well known to the skilled person and include for example sufficient relaxation time etc. In practice the intensity of a signal is obtained from its integral, i.e. the corresponding area. The data is acquired using proton decoupling, 2000 to 4000 scans per spectrum with 10 mm room temperature through or 240 scans per spectrum with a 10 mm cryoprobe, a pulse repetition delay of 11 seconds and a spectral width of 25000 Hz(+/−3000 Hz). The sample is prepared by dissolving a sufficient amount of polymer in 1,2,4-trichlorobenzene (TCB, 99%, spectroscopic grade) at 130° C. and occasional agitation to homogenise the sample, followed by the addition of hexadeuterobenzene (C₆D₆, spectroscopic grade) and a minor amount of hexamethyldisiloxane (HMDS, 99.5+%), with HMDS serving as internal standard. To give an example, about 200 mg to 600 mg of polymer are dissolved in 2.0 mL of TCB, followed by addition of 0.5 mL of C₆D₆ and 2 to 3 drops of HMDS.

Following data acquisition the chemical shifts are referenced to the signal of the internal standard HMDS, which is assigned a value of 2.03 ppm.

The comonomer content of a polypropylene or of a polyethylene is determined by ¹³C-NMR analysis of pellets according to the method described by G.J. Ray et al. in Macromolecules, vol. 10, n° 4, 1977, p. 773-778.

Melting temperatures Tₘ were determined according to ISO 3146:2000 on a DSC Q2000 instrument by TA Instruments.

Temperature Rising Elution Fractionation analysis (TREF analysis) was performed using the method similar to as described in Soares and Hamielec, Polymer, 36 (10), 1995 1639-1654, incorporated herein in its entirety by reference. The TREF analysis was performed on a TREF model 200 series instrument equipped with Infrared detector from Polymer Char. The samples were dissolved in 1,2-dichlorobenzene at 150° C. for 1 h. The following parameters as shown in Table 1 were used.

TABLE 1
METHOD INFORMATION

| | |
|---|---|
| Dissolution Rate (° C./min) | 40 |
| Stabilization Rate (° C./min) | 40 |
| Crystallization Rate 1(° C./min) | 0.5 |
| Elution Rate (° C./min) | 1 |
| Cleaning rate (° C./min) | 30 |
| Dissolution temperature (° C.) | 150 |
| Stabilization temperature (° C.) | 95 |
| Crystallization temperature (° C.) | 35 |
| Elution init temp (° C.) | 35 |
| Elution temperature (° C.) | 140 |
| Post elution temperature (° C.) | 150 |
| Cleaning temperature (° C.) | 150 |
| Dissolution time (min) | 60 |
| Stabilization time (min) | 45 |
| Crystallization time (min) | 10 |
| Pre-injection time (min) | 10 |
| Soluble Fraction time (min) | 10 |
| post elution time (min) | 10 |
| High rpm | 200 |
| Low rpm | 100 |
| T on (s) | 5 |
| T off (s) | 120 |
| Dissolution stirring | High |
| Stabilization stirring | High |
| Filling vessels volume (mL) | 20 |
| Filling vessels pick up speed (mL/min) | 40 |
| Filling vessels pump speed (mL/min) | 15 |
| Analysis discarded sample volume (mL) | 2 |
| Analysis discarded waste volume (mL) | 6 |
| Analysis sample volume (mL) | 0.3 |
| Column load volume (mL) | 1.9 |
| Analysis waste volume (mL) | 5 |
| Analysis returned volume (mL) | 1 |
| Analysis pick up rate (mL/min) | 8 |
| Analysis dispensing rate (mL/min) | 3 |
| Cleaning volume (mL) | 30 |
| Cleaning pick up speed (mL/min) | 40 |
| Cleaning pump speed (mL/min) | 15 |
| Top oven temperature (° C.) | 140 |
| Pump Flow (mL/min) | 0.5 |

Mass spectrometry: Samples were analyzed using APPI (Atmospheric Pressure Photolonization): lampe UV (Krypton, 10.6 eV) coupled with IMS-MS (Ion Mobility Spectrometry-Mass Spectrometry) detector using the method known in the art.

The following non-limiting examples illustrate the invention.

### EXAMPLES

The present invention will be further described with reference to the following examples, but it should be construed that the invention is in no way limited to those examples.

### Example 1: Synthesis of the Proligands

The fluorenyl-cyclopentadienyl type proligands (Cp/Flu proligands) of the catalysts have been synthetized by nucleophilic additions of fluorenyl anions to fulvenes (i.e. the “fulvene method”). By comparison to the patent literature, in the procedure used the sodium methanolate was replaced by pyrolidine as additive of the reaction. The synthesis of para-substituted difulvenes (1a-b) was obtained according to reaction scheme 1:

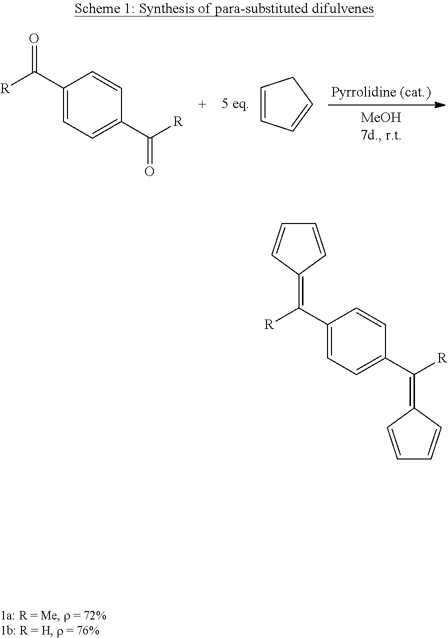

1,4-Bis(1-(cyclopenta-2,4-dien-1-ylidene)ethyl)benzene (la): In a 250 mL round bottom flask equipped with a magnetic stirring bar and a nitrogen inlet freshly cracked cyclopentadiene (12.36 mL, 148 mmol) and 1,4-diacetylbenzene (4.82 g, 30 mmol) were dissolved in methanol (200 mL). To this solution pyrrolidine (7.5 mL, 89 mmol) was added at 0° C. The reaction mixture was stirred at room temperature for 7 days. After neutralization with glacial acetic acid (7.5 mL) and separation of the organic phase, volatiles were evaporated under vacuum to give a yellow powder (5.51 g, 21.3 mmol, 72%).

1,4-Bis(cyclopenta-2,4-dien-1-ylidenemethyl)benzene (1b): Using a protocol similar to that described above for 1,4-bis(1-(cyclopenta-2,4-dien-1-ylidene)ethyl)benzene, 1,4-bis(cyclopenta-2,4-dien-1-ylidenemethyl)benzene was prepared from cyclopentadiene (30.7 mL, 373 mmol), 1,3-terephthalaldehyde (10.0 g, 74.5 mmol) and pyrrolidine (9.3 mL, 112 mmol) and isolated as an orange powder (13.03 g, 56.7 mmol, 76%).

The synthesis of meta-substituted difulvenes (1c-d) was obtained according to reaction scheme 2:

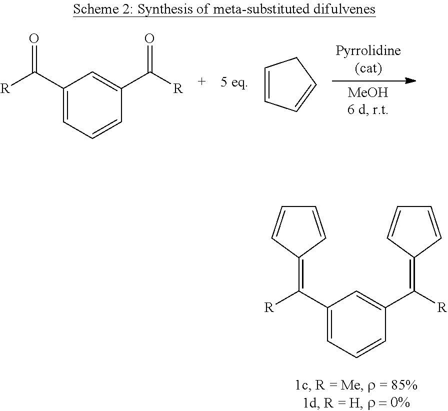

1,3-Bis(1-(cyclopenta-2,4-dien-1-ylidene)ethyl)benzene (1c): Using a protocol similar to that described above for 1,4-bis(1-(cyclopenta-2,4-dien-1-ylidene)ethyl)benzene, 1,3-bis(1-(cyclopenta-2,4-dien-1-ylidene)ethyl)benzene was prepared from cyclopentadiene (30.0 mL, 363 mmol), 1,3-diacetylbenzene (11.0 g, 68 mmol) and pyrrolidine (17.0 mL, 204 mmol) and isolated as an orange powder (14.9 g, 51 mmol, 85%).

Compounds 1a-c were obtained in very good yields but the corresponding meta-substituted difulvene 1d could not be obtained using this procedure, or Thiele's procedure (using methalonate instead of pyrrolidine) or even by using sodium cyclopentadienyl as reactant.

Then, to prepare the target bis{fluorenyl-cyclopentadienyl} type proligands (2a-c), these difulvenes were subsequently induced in a reaction with two equivalents of [3,6-^{t}Bu₂Flu]⁻ Li⁺ as described in reaction scheme 3 starting from the para-substituted difulvenes and in reaction scheme 4 starting from the meta-substituted difulvenes:

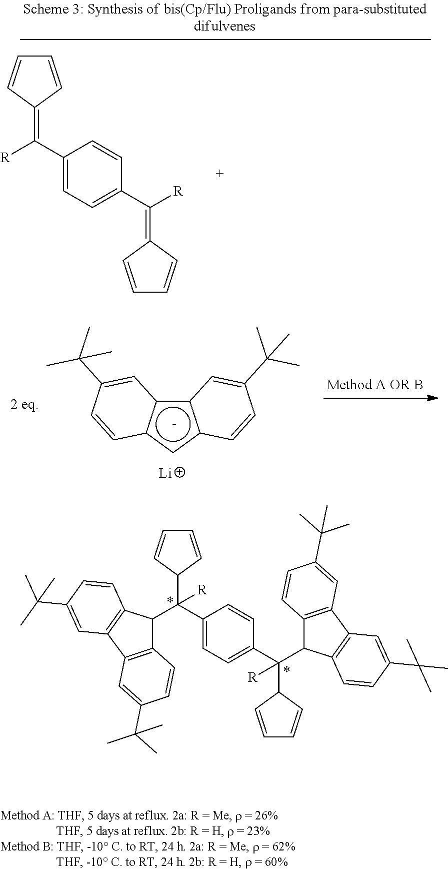

Two methods were investigated to obtain these proligands, and the yields could be improved by carrying out the addition of fluorenyllithium solution to the difulvene solution at −10° C. (Method B).

### 1,4-Bis(1-(cyclopentadienyl)-1-(3,6-di-tert-butyl-fluorenyl)ethyl)benzene (2a)

Method A: In a Schlenk flask, to a solution of 3,6-di-tert-butyl-fluorene (2.17 g, 7.8 mmol) in THF (100 mL) was added n-butyllithium (3.13 mL of a 2.5 M solution in hexane, 7.8 mmol). This solution was added dropwise to a solution of 1,3-bis(1-(cyclopenta-2,4-dien-1-ylidene)ethyl)benzene (1.00 g, 3.9 mmol) in THF (100 mL) at room temperature over 10 minutes. The reaction mixture was stirred for 5 days under reflux. The mixture was hydrolyzed with 10% aqueous hydrochloric acid (20 mL), the organic phase was dried over sodium sulfate, and the solvent was evaporated in vacuo. The resulting solid was washed with pentane (200 mL) and dried to obtain a white powder (731 mg, 0.91 mmol, 26%).

Method B: The procedure is similar to the previous Method A, except that addition of the fluorenyllithium solution was carried out at −10° C. over 10 min. After completion of the addition, the reaction mixture was stirred 24 h at room temperature. Identical workup afforded the title compound as a white powder (1.96 g, 2.4 mmol, 62%).

### 1,4-Bis(1-(cyclopentadienyl)-1-(3,6-di-tert-butyl-fluorenyl)methyl)benzene (2b)

Method A: Using a protocol similar to that described above for 1,4-bis(1-(cyclopentadienyl)-1-(3,6-di-tert-butyl-fluorenyl)ethyl)benzene, the title compound was prepared from 3,6-di-tert-butyl-fluorene (4.83 g, 17.4 mmol), n-butyllithium (7.0 mL of a 2.5 M solution in hexane, 17.4 mmol), 1,4-bis(cyclopenta-2,4-dien-1-ylidenemethyl)benzene (2.00 g, 8.7 mmol) and isolated as a white powder (1.66 g, 2.1 mmol, 23%).

Method B: Using a protocol similar to that described above for 1,4-bis(1-(cyclopentadienyl)-1-(3,6-di-tert-butyl-fluorenyl)ethyl)benzene, the title compound was prepared from 3,6-di-tert-butyl-fluorene (4.83 g, 17.4 mmol), n-butyllithium (7.0 mL of a 2.5 M solution in hexane, 17.4 mmol), 1,4-bis(cyclopenta-2,4-dien-1-ylidenemethyl)benzene (2.00 g, 8.7 mmol) and isolated as a white powder.

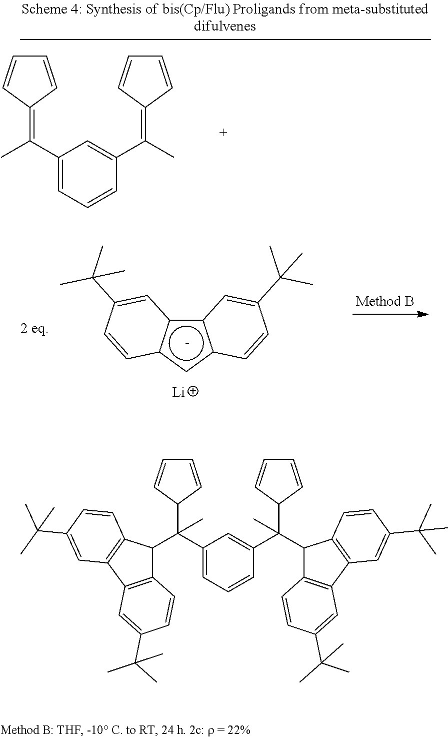

### 1,3-Bis(1-(cyclopentadienyl)-1-(3,6-di-tert-butyl-fluorenyl)ethyl)benzene (2c)

Method B: In a Schlenk flask, to a solution of 3,6-di-tert-butyl-fluorene (2.17 g, 7.8 mmol) in THF (50 mL) was added n-butyllithium (3.13 mL of a 2.5 M solution in hexane, 7.8 mmol). This solution was added dropwise to a solution of 1,3-bis(1-(cyclopenta-2,4-dien-1-ylidene)ethyl)benzene (1.00 g, 3.9 mmol) at −10° C. over 10 min. After completion of the addition, the reaction mixture was stirred for 24 h at room temperature. The mixture was hydrolyzed with 10% aqueous hydrochloric acid (20 mL), the organic phase was separated and dried over sodium sulfate, and the solvent was evaporated in vacuo. The resulting solid was washed with pentane (100 mL) and dried to afford a white powder (469 mg, 0.58 mmol, 22%).

### Example 2: Synthesis of Homo Bis(Metallocene)

Bis(metallocene) zirconium complexes were obtained using a standard salt metathesis reaction between 2 equivalents of the corresponding tetrachloride precursors (ZrCl₄) and tetra anion ligands, prepared in situ via addition of four equivalents of n-butyllithium to the corresponding proligands in Et₂O, in accordance with reaction Schemes 5 and 6.

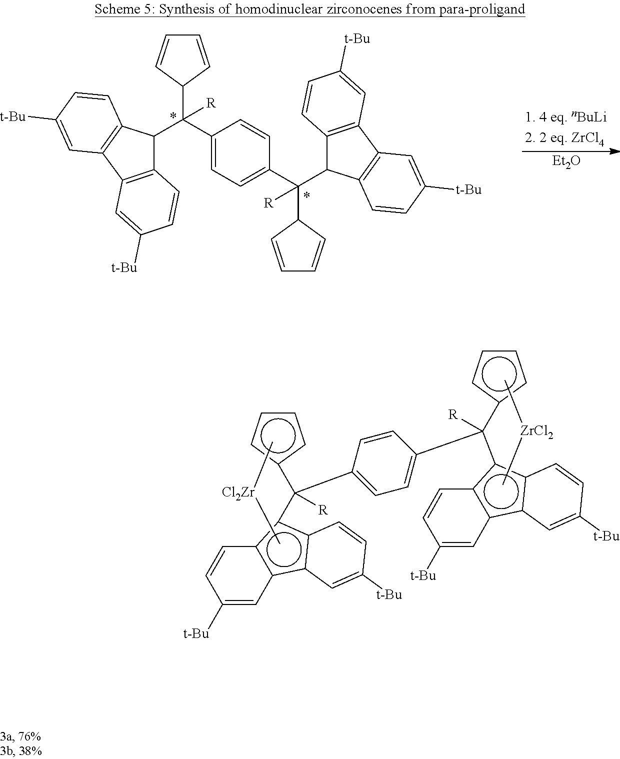

### 1,4-Benzenebis{(cyclopenta-2,4-dien-1-yl(3,6-di-tert-butyl-fluoren-9-yl)ethyl)zirconiumdichloride} (3a)

To a solution of 1,4-bis(cyclopenta-2,4-dien-1-yl(3,6-di-tert-butyl-fluoren-9-yl)ethyl)benzene (0.50 g 0.61 mmol) in diethyl ether (50 mL) was added under stirring n-butyllithium (0.98 mL of a 2.0 M solution in hexane, 2.45 mmol, 4 equiv.). The solution was kept overnight at room temperature. Then ZrCl₄ (0.286 g, 1.23 mmol, 2 equiv.) was added with a bent finger. The resulting red mixture was stirred at room temperature overnight. Then, the mixture was evaporated under vacuum, CH₂Cl₂ (20 mL) was added, the resulting solution was filtered and the solvent was evaporated in vacuo to give a red powder (0.528 g, 0.46 mmol, 76%).

### 1,4-Benzenebis{(cyclopenta-2,4-dien-1-yl(3,6-di-tert-butyl-fluoren-9-yl)methyl)zirconiumdichloride} (3b)

This compound was prepared as described above for 3a, starting from 1,4-bis(cyclopenta-2,4-dien-1-yl(3,6-di-tert-butyl-fluoren-9-yl)methyl)benzene (0.66 g, 0.84 mmol), n-butyllithium (1.37 mL of a 2.0 M solution in hexane, 3.37 mmol, 4 equiv.) and ZrCl₄ (0.392 g, 1.68 mmol, 2 equiv.). The compound was isolated as a red powder (0.350 g, 0.32 mmol, 38%).

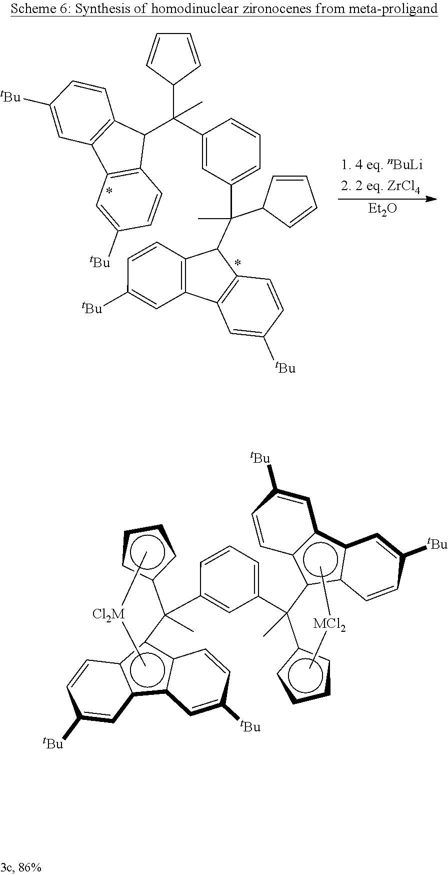

### 1,3-Benzenebis{(cyclopenta-2,4-dien-1-yl(3,6-di-tert-butyl-fluoren-9-yl)ethyl)zirconiumdichloride} (3c)

This compound was prepared as described above for 3a starting from 3,6-di-tert-butyl-9-(1-(cyclopenta-2,4-dien-1-yl)-1-phenylethyl)-9H-fluorene (0.52 g, 0.64 mmol), n-butyllithium (1.0 mL of a 2.5 M solution in hexane, 2.55 mmol, 2 equiv.) and ZrCl₄ (0.30 g, 1.27 mmol). The product was isolated as a red powder (0.63 g, 0.56 mmol, 87%).

Dinuclear hafnium complexes were obtained using the same standard salt metathesis reaction between 2 equivalents of the corresponding tetrachloride precursors (HfCl₄) and ligand tetra anions, prepared in situ via addition of four equivalents of n-butyllithium to the corresponding proligands in Et₂O, in accordance with reaction Scheme 7.

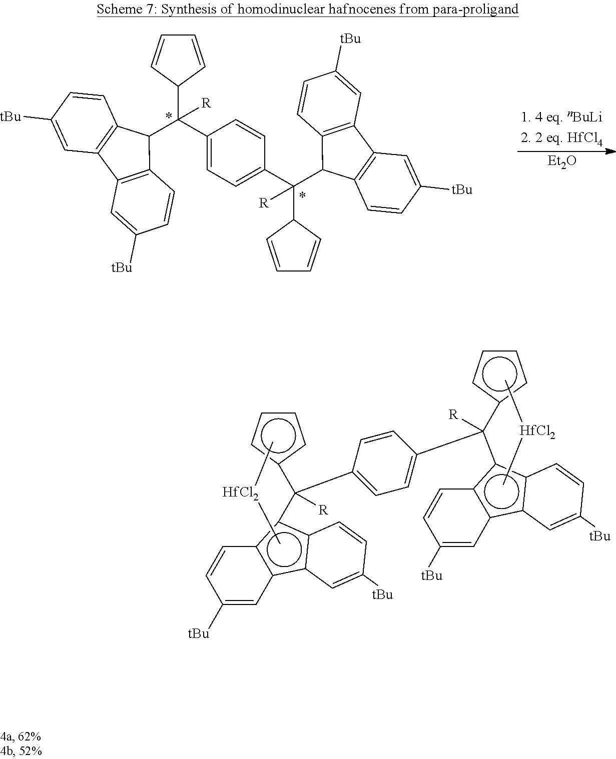

### 1,4-benzenebis{(cyclopenta-2,4-dien-1-yl(3,6-di-tert-butyl-fluoren-9-yl)ethyl)hafniumdichloride} (4a)

This compound was prepared as described above for 3a starting from 1,4-bis(cyclopenta-2,4-dien-1-yl(3,6-di-tert-butyl-fluoren-9-yl)ethyl)benzene (0.50 g, 0.61 mmol), n-butyllithium (0.98 mL of a 2.5 M solution in hexane, 2.45 mmol, 4 equiv.) and HfCl₄ (2 equiv.). The compound was recovered as a yellow powder (0.52 g, 0.38 mmol, 62%).

### 1,4-benzenebis{(cyclopenta-2,4-dien-1-yl(3,6-di-tert-butyl-fluoren-9-yl)methyl)hafniumdichloride} (4b)

This compound was prepared as described above for 3a starting from 1,4-bis(cyclopenta-2,4-dien-1-yl(3,6-di-tert-butyl-fluoren-9-yl)methyl)benzene (0.50 g, 0.61 mmol), n-butyllithium (0.98 mL of a 2.5 M solution in hexane, 2.45 mmol, 4 equiv.) and HfCl₄ (2 equiv.). The compound was recovered as a yellow powder (0.43 g, 52%).

### Example 3: Synthesis of Hetero Bis(Metallocene)

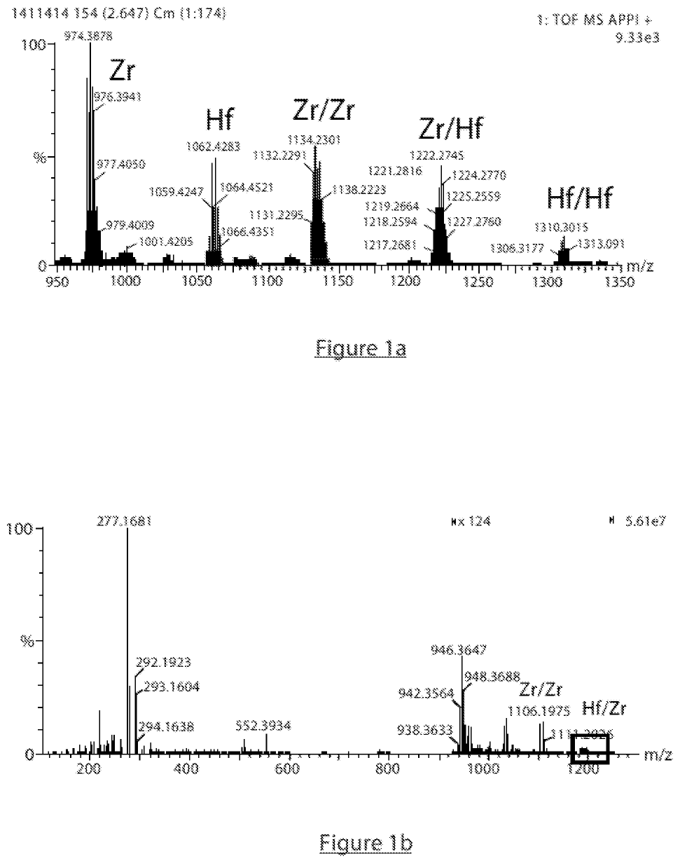

Hetero bis(metallocene) complexes were obtained using a salt metathesis reaction between one equivalent of each tetrachloride precursors (ZrCl₄ and HfCl₄) and ligand tetra anions, prepared in situ via addition of four equivalents of n-butyllithium to the corresponding proligands in Et₂O, in accordance with reaction scheme 8. The products of these reactions are mixtures of homo and hetero bis(metallocene) complexes. The presence of hetero bis(metallocene) complexes has been evidenced by mass spectrometry. FIG. 1 shows the mass spectrum of 5a.

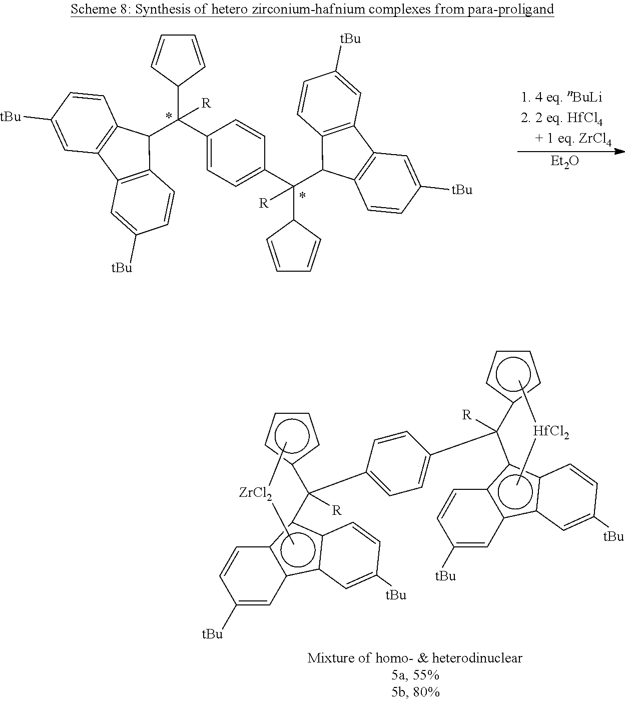

### 1,4-benzenebis{(cyclopenta-2,4-dien-1-yl(3,6-di-tert-butyl-fluoren-9-yl)ethyl)zirconiumhafniumdichloride} (5a)

This compound was prepared as described above for 3a starting from 1,4-bis(cyclopenta-2,4-dien-1-yl(3,6-di-tert-butyl-fluoren-9-yl)ethyl)benzene (1 g, 1 equiv.), n-butyllithium (2.5 M solution in hexane, 4 equiv.) and ZrCl₄ (1 equiv.) and HfCl₄ (1 equiv.). The compound was recovered as a yellow powder (0.8 g, 55%).

### 1,4-benzenebis{(cyclopenta-2,4-dien-1-yl(3,6-di-tert-butyl-fluoren-9-yl)methyl)zirconiumhafniumdichloride} (5b)

This compound was prepared as described above for 3a starting from 1,4-bis(cyclopenta-2,4-dien-1-yl(3,6-di-tert-butyl-fluoren-9-yl)methyl)benzene (1 g, 1 equiv.), n-butyllithium (2.5 M solution in hexane, 4 equiv.) and ZrCl₄ (1 equiv.) and HfCl₄ (1 equiv.). The compound was recovered as a yellow powder (1.2 g, 80%).

### Example 4: Synthesis of Mononuclear Metallocene Analogues

To investigate the catalytic properties of the bis(metallocene)complexes according to the invention in olefin polymerisation, their mononuclear analogues were also synthetized according to reaction scheme 9. Complexes 3a′ and 3b′ were isolated in very good yields.

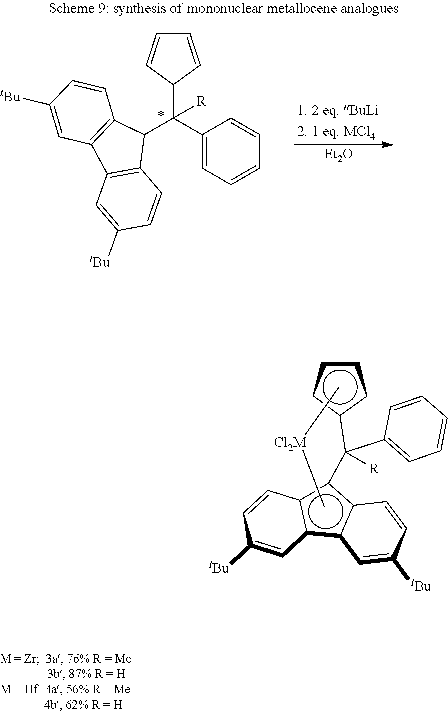

{Ph(Me)C-(3,6-^{t}Bu₂Flu)(Cp)}ZrCl₂ (3a′): This compound was prepared as described above for 3a starting from 3,6-di-tert-butyl-9-(1-(cyclopenta-2,4-dien-1-yl)-1-phenylethyl)-9H-fluorene (0.40 g 0.89 mmol), n-butyllithium (0.72 mL of a 2.5 M solution in hexane, 1.79 mmol, 2 equiv.) and ZrCl₄ (0.209 g, 0.89 mmol, 1 equiv.). The compound was isolated as a red powder (0.410 g, 0.67 mmol, 76%).

{Ph(H)C-(3,6-^{t}Bu₂Flu)(Cp)}ZrCl₂ (3b′): This compound was prepared as described above for 3a starting from 3,6-di-tert-butyl-9-(1-(cyclopenta-2,4-dien-1-yl)-1-phenylethyl)-9H-fluorene (0.43 g, 0.99 mmol), n-butyllithium (0.81 mL of a 2.5 M solution in hexane, 1.99 mmol, 2 equiv.) and ZrCl₄ (0.23 g, 0.99 mmol). The product was isolated as a red powder (0.54 g, 0.86 mmol, 87%).

{Ph(Me)C-(3,6-^{t}Bu₂Flu)(Cp)HfCl₂ (4a′): This compound was prepared as described above for 3a starting from 3,6-di-tert-butyl-9-(1-(cyclopenta-2,4-dien-1-yl)-1-phenylethyl)-9H-fluorene (0.40 g, 0.89 mmol), n-butyllithium (0.72 mL of a 2.5 M solution in hexane, 1.79 mmol, 2 equiv.) and HfCl₄ (1 equiv.). The compound was isolated as a yellow powder (yield: 56%).

{Ph(H)C-(3,6-^{t}Bu₂Flu)(Cp)}HfCl₂ (4b′): This compound was prepared as described above for 3a starting from 3,6-di-tert-butyl-9-(1-(cyclopenta-2,4-dien-1-yl)-1-phenylethyl)-9H-fluorene (0.43 g, 0.99 mmol), n-butyllithium (0.81 mL of a 2.5 M solution in hexane, 1.99 mmol, 2 equiv.) and HfCl₄ (1 equiv.). The product was isolated as a yellow powder (yield: 62%).

### Example 5: Ethylene Homogenous Polymerisation

To evaluate potential cooperativity effects in these bis(metallocene) complexes for olefin polymerisation, their ethylene polymerisation behaviors were compared with those of the corresponding mononuclear analogues.

Polymerisations were performed in a 300 mL high-pressure glass reactor equipped with a mechanical stirrer (Pelton turbine) and externally heated with a double mantle with a circulating water bath. The reactor was filled with toluene (100 mL) and MAO (0.20 mL of a 30 wt % solution in toluene) and pressurized at 5.5 bar of ethylene (Air Liquide, 99.99%). The reactor was thermally equilibrated at the desired temperature for 30 min, the ethylene pressure was decreased to 1 bar, and a solution of the catalyst precursor in toluene (ca. 2 mL) was added by syringe. The ethylene pressure was immediately increased to 5.5 bar (kept constant with a back regulator) and the solution was stirred for the desired time (typically 15 min). The temperature inside the reactor (typically 60° C.) was monitored using a thermocouple. The polymerisation was stopped by venting the vessel and quenching with a 10% HCl solution in methanol (ca. 2 mL). The polymer was precipitated in methanol (ca. 200 mL), and 35% aqueous HCl (ca. 1 mL) was added to dissolve possible catalyst residues. The polymer was collected by filtration, washed with methanol (ca. 200 mL), and dried under vacuum overnight.

Each polymerisation was repeated independently two times under the same conditions (toluene, 5.5 bar of ethylene, 60° C.). The mono and bis(metallocene)complexes were activated by treatment with a large excess of methylalumoxane ([Al/Zr]=1000). Polymerisation results are summarized in Table 2, revealing good reproducibility in terms of activity and physicochemical properties (Tₘ) of the isolated polymer.

For dinuclear hafnocene 4a, 300 equiv. of BHT were added in order to increase the productivity. In fact, it is known that the “free” AlMe₃ present in MAO can form Me-bridged adducts with hafnocene that makes them catalytically inactive (see V. Busico et al. in Macromolecules, 2009, 42, 1789). To prevent the formation of such “dormant” species, BHT can be added in situ in order to scavenge the excess of TMA.

TABLE 2
Ethylene polymerisation:
Reaction conditions: 60° C., n(Zr) = ca. 1.0 μmol, pressure = 5.5 bar
ethylene, [Al]/[Zr] = 1000, time = 15 min, V = 100 mL toluene.

| | | PE | Productivity | Mw | | Tₘ | % C3 | % C4 | % C6 |
|---|---|---|---|---|---|---|---|---|---|
| Ref | Complex | (g) | (kg · mol⁻¹ · h⁻¹) | (g · mol⁻¹) | Mw/Mn | (° C.) | (wt %) | (wt %) | (wt %) |
| ET01 | 3b | 5.82 | 23,280 | 134,600 | 3.1 | 127.2 | 1.5 | 0.2 | 0.0 |
| ET02 | 3b | 5.20 | 20,800 | 189,200 | 3.5 | 129.0 | 0.0 | 0.2 | 0.0 |
| ET03 | 3b′ | 6.79 | 27,160 | 180,900 | 3.4 | 132.1 | 0.0 | 0.1 | 0.0 |
| ET04 | 3a | 6.20 | 24,800 | 175,100 | 3.2 | 132.3 | 0.0 | 0.1 | 0.0 |
| ET05 | 3a | 5.62 | 22,500 | 196,600 | 3.4 | 132.2 | 0.0 | 0.2 | 0.0 |
| ET06 | 3a′ | 5.64 | 22,600 | 260,400 | 3.6 | 132.1 | 0.0 | 0.1 | 0.0 |
| ET07 | 3a′ | 6.14 | 24,600 | 307,900 | 4.1 | 131.8 | 0.0 | 0.0 | 0.0 |
| ET08 | 3c | 4.96 | 19.800 | 85,000 | 3.3 | nd | 0.0 | 0.2 | 0.0 |
| ET09 | 4a | 1.53 | 6,100 | Ins. | Ins. | 132.7 | 0.0 | 0.0 | 0.0 |
| ET10 | 4a | 1.63 | 6,500 | Ins. | Ins. | 133.6 | 0.0 | 0.0 | 0.0 |

ET03, ET06 and ET07 are comparative examples as the polyethylene was produced by a mononuclear metallocene.

Ethylene polymerisation with these bis(metallocene) (3a-b) did not exhibit a significant difference in productivity compared to their mononuclear analogues. However, dinuclear zirconocene 3a exhibited somehow decreased molecular weight versus its mononuclear counterpart (3a′).

### Example 6: Ethylene/1-hexene Copolymerisation

Ethylene/1-hexene copolymerisations were performed following the same procedure as described above for ethylene homopolymerisation.

Ethylene/1-hexene copolymerisations were performed in the same 300 mL high-pressure glass reactor following the same procedure as described above. Only 1-hexene (typically 2.5 mL) was introduced in the initial stages. The workup was identical.

Copolymerisation results are summarized in Table 3.

TABLE 3
Ethylene/1-hexene copolymerisation:
Reaction conditions: 60° C., n(Zr) = ca. 1.0 μmol), pressure = 5.5 bar
ethylene, [1-hexene]₀ = 0.2M, [Al]/[Zr] = 1000, time = 15 min, V = 100 mL toluene.

| | | PE | Productivity | M_{w} | | Tₘ | % C3 | % C4 | % C6 |
|---|---|---|---|---|---|---|---|---|---|
| Run | Complex | (g) | (kg · mol⁻¹ · h⁻¹) | (g · mol⁻¹) | M_{w}/Mₙ | (° C.) | (wt %) | (wt %) | (wt %) |
| ET11 | 3b | 7.74 | 31,000 | 75,800 | 2.8 | 111.4 | 0.9 | 0.1 | 22.5 |
| ET12 | 3b | 6.70 | 26,800 | 64,000 | 2.7 | 112.2 | 0.4 | 0.1 | 19.4 |
| ET13 | 3b′ | 7.57 | 30,300 | 89,900 | 2.7 | 113.9 | 0.0 | 0.0 | 21.1 |
| ET14 | 3b′ | 7.30 | 29,200 | 96,900 | 2.9 | 108.2 | 0.0 | 0.0 | 22.7 |
| ET15 | 3a | 6.20 | 24,800 | 70,600 | 2.6 | 122.5 | 0.0 | 0.1 | 15.7 |
| ET16 | 3a | 5.62 | 22,500 | 84,300 | 3.0 | 123.8 | 0.0 | 0.0 | 23.2 |
| ET17 | 3a′ | 7.22 | 28,900 | 129,300 | 3.4 | 117.7 | 0.0 | 0.0 | 22.6 |
| ET18 | 3a′ | 6.77 | 27,100 | 132,100 | 3.3 | 118.2 | 0.0 | 0.0 | 21.3 |
| ET19 | 3c | 7.75 | 31,000 | 190,600 | 3.5 | nd | 0.0 | 0.0 | 21.3 |
| ET20 | 4a | 3.78 | 15,100 | 447,100 | 3.1 | / | 0.0 | 0.0 | 28.1 |
| ET21 | 4a | 4.34 | 17,400 | 581,500 | 4.0 | / | 0.0 | 0.0 | 29.6 |

ET13, ET14, ET17 and ET18 are comparative examples as the polyethylene was produced by a mononuclear metallocene.

For ethylene/1-hexene copolymerisation, no significant cooperative effects were observed in terms of productivity or incorporation of 1-hexene compared to their mononuclear analogues. On the other hand, dinuclear zirconocene 3a led to decreased molecular weight versus its mononuclear counterpart 3a′. That is in line with its abovementioned behavior in ethylene homopolymerisation.

It can be concluded that the phenylene bridged dinuclear zirconocenes according to the invention exhibit high catalytic activities in polymerisation of ethylene as well as in copolymerisation of ethylene with 1-hexene, and also a significant comonomer incorporation rate. It has been observed similar catalytic properties between the mono- and the bis(metallocene)complexes in term of activity, molecular weight of the polymer or comonomer incorporation rate. However, difference in crystallinity of the obtained polyolefin have been found.

### Example 7: Ethylene Polymerization using Heterogenized Catalysts

Preparation of Heterogenized Metallocenes

MAO Treatment

20 g of spray dried silica (D50=42 μm; Surface area=280 m²/g; Pore volume=1.5 ml/g; 2 wt % titanium) were introduced in 500 mL round-bottomed flask. Dry toluene (200 mL) was added and the suspension was stirred using a mechanical stirrer. MAO (30% in toluene, 42 mL) was added dropwise and the suspension was heated to 110° C. for 4 hours. The suspension was cooled down to room temperature and filtered over glass frit, washed three times with 30 mL of toluene and three times with 30 mL of dry pentane. The SMAO powder was then dried overnight under reduced pressure.

Metallocene Treatment

In a 250 ml round bottom flask, 10 g of the above-obtained SMAO were suspended in 80 ml of dry toluene. Then, 0.2 g of metallocene in 20 mL of toluene were added and the resulting suspension was stirred during 2 hours at room temperature. The heterogenized metallocene was filtered over a glass frit, washed with toluene and pentane then dried overnight under reduced pressure.

Polymerisation Conditions

Polymerization reactions were performed in a 4 L liter autoclave with an agitator, a temperature controller and inlets for feeding of propylene and hydrogen.

The reactor was dried at 130° C. with nitrogen during one hour and then cooled to 85° C. Reactor was loaded with isobutene (2L), 1-hexene (40 mL) and triisobutylaluminum (3 mL of a 10 wt % solution in n-hexane) and pressurized with 23.7 bar of ethylene with 800 ppm of hydrogen. Catalyst (0.1 g) was diluted with triisobutylaluminum (0.8 mL of a 10 wt % solution in n-hexane. Polymerization started upon catalyst injection and was stopped after 60 minutes by reactor depressurization. Reactor was flushed with nitrogen prior opening and the polymer was recovered as a free flowing powder.

TABLE 4
Ethylene polymerisation

| | supported | activity | GPC | | | | | NMR |
|---|---|---|---|---|---|---|---|---|
| Ref | metallocene | g/g/h | Mn | Mw | Mz | Mw/Mn | Mz/Mw | % C6 |
| ET22 | 3b′ | 3057 | 47185 | 214116 | 588530 | 4.5 | 2.7 | 4.78 |
| ET23 | 3a′ | 1819 | 51051 | 187824 | 509281 | 3.7 | 2.7 | 5.30 |
| ET24 | 3a | 2873 | 47483 | 179788 | 593834 | 3.8 | 3.3 | 3.46 |
| ET25 | 5a | 1827 | 48549 | 159611 | 502968 | 3.3 | 3.2 | 4.54 |
| ET26 | 5b | 1070 | 38572 | 114090 | 365896 | 3.0 | 3.2 | 6.45 |
| ET27 | 3b | 923 | 47007 | 156799 | 473463 | 3.3 | 3.0 | 5.76 |
| ET28 | 4b | No activity | — | — | — | — | — | — |
| ET29 | 4a | No activity | — | — | — | — | — | — |
| ET30 | 4b′ | No activity | — | — | — | — | — | — |
| ET31 | 4a′ | No activity | — | — | — | — | — | — |

ET22, ET23, ET30 and ET31 are comparative examples as the catalyst used was a mononuclear metallocene.

ET28 and ET29 are also comparative examples as the dinuclar metallocene used did not contain Zirconium.

From the results it can be seen that 4a and 4b exhibit activity under homogeneous conditions (Tables 2 and 3) while no activity was recorder using heterogenized/supported conditions (Table 4).

### Example 8: Crystallinity of the Obtained Polymers

Crystallinity analysis have been performed on high-density polyethylene (HDPE) obtained with different catalysts including the catalyst according to the invention. Samples 1, 2 & 3 hereafter correspond to ET22, ET27 & ET26, respectively.

Sample 1 was a HDPE resin synthesized with a Zirconium mononuclear complex.

Sample 2 was a HDPE resin synthesized with a Zirconium hetero bis(metallocene) complex (Zr—Hf) according to the invention.

Sample 3 was a HDPE resin synthesized with a Zirconium homo bis(metallocene) complex (Zr—Zr) according to the invention.

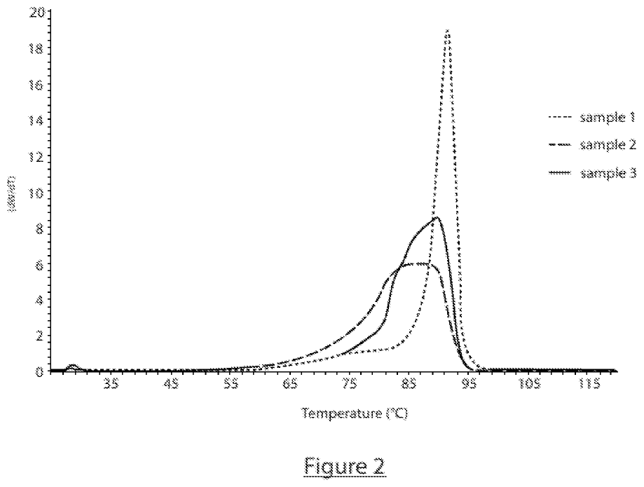

The resins of the three samples were fractionated by a Temperature Rising Elution Fractionation (TREF) process. The results are shown in FIG. 2.

Table 5 shows the results of the TREF analysis:

TABLE 5

| | T^{a} (° C.) - | Peak 1 | Soluble fraction |
|---|---|---|---|
| Sample | Peak 1 | area | (%) (35° C.) |
| Sample 1 | 91.4 | 99.5 | 0.5 |
| Sample 2 | 87.5 | 99.3 | 0.7 |
| Sample 3 | 89.4 | 99.1 | 0.9 |

Surprisingly, from FIG. 2 it is clear that the peaks obtained for HDPE polymerised with Zirconium binuclear complex are broader than the one obtained for HDPE polymerised with Zirconium mononuclear complex. In fact there is a broadening of the peaks from monometallic to homo bis(metallocene) and hetero bis(metallocene). Such broadening reveals a bimodal structure of the polymer.

The TREF results demonstrates a synergic effect between the two components of the bis(metallocene) complex. Also, it can be seen that this synergetic effect is also shown for hetero bis(metallocene) complex Zr—Hf. This shows that the hafnium component of the bis(metallocene) complex is activated by the presence of the zirconium component. This is surprising as the hafnium mono- or bis(metallocene) complex were found to be inactive.

### Example 9: Polypropylene Polymerisation

Polymerisation reactions were performed in a 8 L autoclave with an agitator, a temperature controller and inlets for feeding of propylene and hydrogen.

The reactor was dried at 130° C. with nitrogen during one hour and then cooled to 60° C. Reactor was loaded with propylene (4.5 L) and hydrogen (0.36 g). Catalyst (0.1 g) was diluted with triethylaluminum (1 mL of a 10 wt % solution in n-hexane. Polymerisation started upon catalyst injection and was stopped after 60 minutes by reactor depressurization. Reactor was flushed with nitrogen prior opening and the polymer was recovered as a free flowing powder.

The results on the obtained polyolefin are displayed in table 6

TABLE 6
Propylene polymerisation

| | supported | activity | GPC | | | | | NMR |
|---|---|---|---|---|---|---|---|---|
| Ref | metallocene | g/g/h | Mn | Mw | Mz | Mw/Mn | Mz/Mw | rrrr |
| PP01 | 3b′ | 1950 | 40331 | 93995 | 166588 | 2.3 | 1.8 | 81.9 |
| PP02 | 3a′ | 390 | 48892 | 126973 | 233516 | 2.6 | 1.8 | 81.8 |
| PP03 | 3a | 270 | 25342 | 71613 | 155601 | 2.8 | 2.2 | 66.7 |
| PP04 | 5a | 350 | 27386 | 113561 | 512086 | 4.1 | 4.5 | 66.7 |
| PP05 | 5b | 410 | 29305 | 133378 | 661228 | 4.6 | 5 | 69.6 |
| PP06 | 3b | 1020 | 24816 | 73940 | 165231 | 3 | 2.2 | 70.1 |
| PP07 | 4b | No activity | — | — | — | — | — | — |
| PP08 | 4a | No activity | — | — | — | — | — | — |
| PP09 | 4b′ | No activity | — | — | — | — | — | — |
| PP10 | 4a′ | No activity | — | — | — | — | — | — |

PP01, PP02, PP09 and PP10 are comparative examples as the catalyst used was a mononuclear metallocene.

PP07 and PP08 are also comparative examples as the dinuclar metallocene used incorporate Hafnium metal.

The polypropylenes produced with Zirconium binuclear complex have molecular weight distributions broader than those of polypropylenes obtained with Zirconium mononuclear complexes. The broadening is more pronounced for hetero bis(metallocene) complex Zr—Hf and reveals a bimodal composition of the polymer. It is believed that the activity of a hafnium component of the bis(metallocene)is affected by the presence of the zirconium component.

This is rather surprising as the hafnium mono- or bis(metallocene) complex were found to be inactive.

1.-15. (canceled)

16. A bis(metallocene) compound (A) having one of the following formulas: 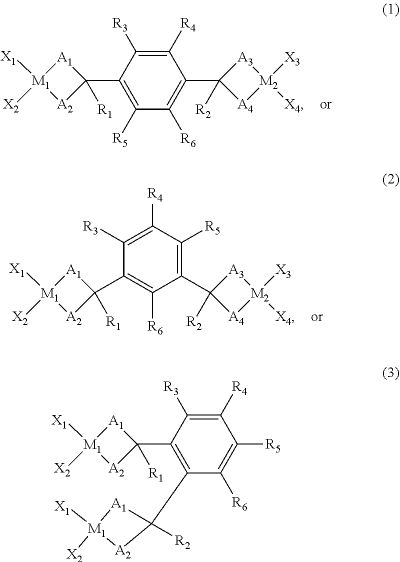
A1 and A3 are the same or different substituted or unsubstituted cyclopentadienyl rings, or substituted or unsubstituted fluorenyl rings, or substituted or unsubstituted indenyl rings, wherein if substituted, the substitutions may be independent and/or linked to form multicyclic structures;
A2 and A4 are the same or different and selected from substituted or unsubstituted cyclopentadienyl rings or substituted or unsubstituted fluorenyl rings, or substituted or unsubstituted indenyl rings;
X1, X2, X3 and X4 are independently hydrogen, halogen, hydride group, hydrocarbyl group, substituted hydrocarbyl group, alkoxide group, substituted alkoxide group, aryloxide group, substituted aryloxide group, halocarbyl group, substituted halocarbyl group, silylcarbyl group, substituted silylcarbyl group, germylcarbyl group, substituted germylcarbyl group, or both X1 and X2 and/or both X3 and X4 are joined and bound to the metal atom to form a metallacycle ring containing from 3 to 20 carbon atoms.
M1 is Zirconium.
M2 is selected from Zirconium, Hafnium and Titanium.
R1 and R2 are independently hydrogen or a substituted or unsubstituted aliphatic, aromatic, or cyclic group.
R3, R4, R5 and R6 are independently hydrogen or a substituted or unsubstituted aliphatic, aromatic, or cyclic group.

17. The bis(metallocene) compound (A) according to claim 16 characterized in that both M1 and M2 are zirconium or M1 and M2 are different and preferably M2 is hafnium.

18. The bis(metallocene) compound (A) according to claim 16 characterized in that A1 and A3 are the same and A2 and A4 are the same so that the bis(metallocene) compound (A) shows a symmetry.

19. The bis(metallocene) compound (A) according to claim 16 characterised in that
R1 and R2 are independently hydrogen or a methyl group, and/or
R3, R4, R5 and R6 are hydrogen, and/or,
at least one of Al, A2, A3 or A4 is a fluorenyl ring.

20. The bis(metallocene) compound (A) according to claim 16 characterized in that the compound is:

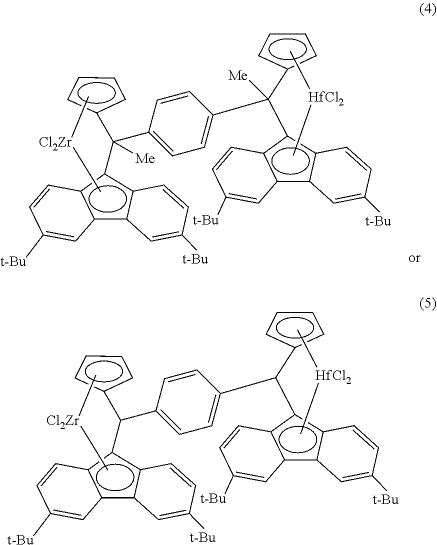

21. A catalyst composition comprising a bis(metallocene) compound (A) according to claim 16 and a co-catalyst (B).

22. The catalyst composition of claim 21 characterized in that the co-catalyst (B) is an alumoxane selected from methylalumoxane, modified methyl alumoxane, ethylalumoxane, isobutylalumoxane, or any combination thereof, preferably the co-catalyst (B) is methylalumoxane (MAO).

23. The catalyst composition of claim 21 characterized in that the co-catalyst is an ionic activator selected from dimethylanilinium tetrakis(perfluorophenyl)borate, triphenylcarbonium tetrakis (perfluorophenyl) borate, dimethylanilinium tetrakis(perfluorophenyl)aluminate, or any combination thereof, preferably the ionic activator is dimethylanilinium tetrakis(perfluorophenyl)borate.

24. The catalyst composition of claim 21 characterized in that the co-catalyst (B) is an ionic activator used in combination with a co-activator being a trialkylaluminium selected from Tri-Ethyl Aluminum (TEAL), Tri-Iso-Butyl Aluminum (TIBAL), Tri-Methyl Aluminum (TMA), and Methyl-Methyl-Ethyl Aluminum (MMEAL), preferably the co-activator is Tri-Iso-Butyl Aluminum (TIBAL).

25. The catalyst composition according to claim 21 characterized in that the bis(metallocene) compound (A) is or comprises a mixture of a homo bis(metallocenes) wherein both M1 and M2 are Zirconium and of a hetero bis(metallocene) wherein M1 and M2 are different metal centers and further wherein preferably M2 is Hafnium.

26. The use of the catalyst composition of claim 21 in a process for polymerising olefins, the process comprising the step of contacting the catalyst composition with an olefin monomer and optionally an olefin comonomer under polymerisation conditions to produce an olefin polymer.

27. The use of claim 26 characterised in that the olefin monomer is ethylene or propylene.

28. A process for preparing a bis(metallocene) compound comprising the steps of conducting a salt-metathesis reaction of a metal precursor and a tetra anion ligand wherein the proligand has one of the following formulas: 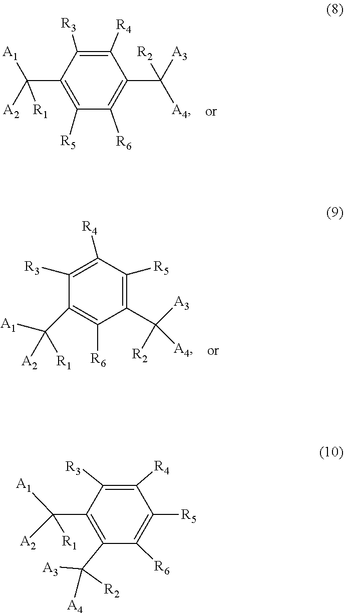
wherein
A1 and A3 are the same or different substituted or unsubstituted cyclopentadienyl rings, or substituted or unsubstituted fluorenyl rings, or substituted or unsubstituted indenyl rings, wherein if substituted, the substitutions may be independent and/or linked to form multicyclic structures.
A2 and A4 are the same or different and selected from substituted or unsubstituted cyclopentadienyl rings, or substituted or unsubstituted fluorenyl rings, or substituted or unsubstituted indenyl rings.
R1 and R2 are independently hydrogen or a substituted or unsubstituted aliphatic, aromatic, or cyclic group.
R3, R4, R5 and R6 are independently hydrogen or a substituted or unsubstituted aliphatic, aromatic, or cyclic group, and
wherein the bis(metallocene) compound comprises a compound having one of the following formulas: 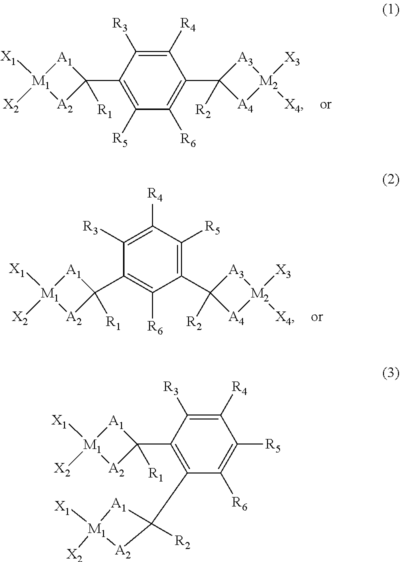
A1 and A3 are the same or different substituted or unsubstituted cyclopentadienyl rings, or substituted or unsubstituted fluorenyl rings, or substituted or unsubstituted indenyl rings, wherein if substituted, the substitutions may be independent and/or linked to form multicyclic structures;
A2 and A4 are the same or different and selected from substituted or unsubstituted cyclopentadienyl rings or substituted or unsubstituted fluorenyl rings, or substituted or unsubstituted indenyl rings;
X1, X2, X3 and X4 are independently hydrogen, halogen, hydride group, hydrocarbyl group, substituted hydrocarbyl group, alkoxide group, substituted alkoxide group, aryloxide group, substituted aryloxide group, halocarbyl group, substituted halocarbyl group, silylcarbyl group, substituted silylcarbyl group, germylcarbyl group, substituted germylcarbyl group, or both X1 and X2 and/or both X3 and X4 are joined and bound to the metal atom to form a metallacycle ring containing from 3 to 20 carbon atoms.
M1 is Zirconium.
M2 is selected from Zirconium, Hafnium and Titanium.
R1 and R2 are independently hydrogen or a substituted or unsubstituted aliphatic, aromatic, or cyclic group.
R3, R4, R5 and R6 are independently hydrogen or a substituted or unsubstituted aliphatic, aromatic, or cyclic group.

29. The process of claim 29 wherein the proligand is a bis (Cp/Flu) proligand of the following formula 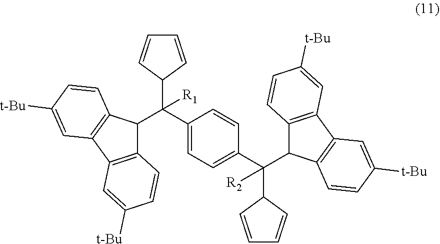
wherein R1 and R2 are independently hydrogen or a substituted or unsubstituted aliphatic, aromatic, or cyclic group.

30. The process according to claim 29 characterized in that the metal precursor is a mixture of zirconium tetrachloride (ZrCl₄) with one selected from zirconium tetrachloride (ZrCl₄), hafnium tetrachloride (HfCl₄) and titanium tetrachloride (TiCl₄).
